(19) United States
(12) Patent Application Publication
(10) Pub. No.: US 2010/0157261 A1
(43) Pub. Date: Jun. 24, 2010

(54) Substrate Treating Apparatus

(76) Inventors: Sang-Geun Lee, Seoul (KR); Min Ho Choi, Hwaseong-si (KR); Hweon Jin, Yongin-si (KR); Jin Suk Kim, Seoul (KR); Jin Sung Kim, Suwon-si (KR); Se-Hwi Cho, Seoul (KR)

Correspondence Address: F. CHAU & ASSOCIATES, LLC, 130 WOODBURY ROAD, WOODBURY, NY, 11797, US

(21) Appl. No.: 12/639,721

(22) Filed: Dec. 16, 2009

(30) Foreign Application Priority Data
Dec. 18, 2008 (KR) 10-2008-0129624

(51) Int. Cl. G03B 27/52

(52) U.S. Cl. 355/30

(57) ABSTRACT

A photolithography process facility comprising a substrate treating apparatus, the substrate treating apparatus includes a temperature control plate controlling a temperature a substrate, a central supporter having a pin shape vertically penetrating the temperature control plate and supporting a central region of substrate, and a collision preventer preventing a collision between the substrate and the temperature control plate.

### CROSS-REFERENCE TO RELATED APPLICATIONS

This application claims priority under 35 U.S.C. §119 to Korean Patent Application No. 10-2008-0129624, filed on Dec. 18, 2008, the entire contents of which are herein incorporated by reference in their entirety.

### BACKGROUND

1. Technical Field

The exemplary embodiments disclosed herein relate to substrates, and more particularly, to photolithography process facility.

2. Discussion of the Related Art

Generally, a photolithography process facility may include a photo facility and a spinner facility. The photo facility performs a photolithography process on a semiconductor substrate. The photo facility may include a stepper for transferring a pattern formed on a photo mask to the semiconductor substrate. The spinner facility performs front and back processes (e.g., a coating process, a developing process, a bake process, etc.) of the photolithography process.

### SUMMARY

Exemplary embodiments of the present inventive concept provide a photolithography process facility including a substrate treating apparatus. The substrate treating apparatus may include a temperature control plate controlling a temperature of a substrate; a central supporter having a pin shape vertically penetrating the temperature control plate and supporting a central region of the substrate; and a collision preventer preventing a collision between the substrate and the temperature control plate.

### BRIEF DESCRIPTION OF THE DRAWINGS

The above and other features and aspects of the exemplary embodiments of the present inventive concept will be described in detail with reference to the accompanying drawings, in which:

FIG. 1 is a view illustrating a photolithography process facility in accordance with an exemplary embodiment of the present inventive concept;

FIG. 2A is a top plan view illustrating an example of a substrate treating apparatus depicted in FIG. 1;

FIG. 2B is a cross section view taken along the line I-I′ depicted in FIG. 2A;

FIG. 3A is a top plan view illustrating a substrate treating apparatus in accordance with an exemplary embodiment of the present inventive concept;

FIG. 3B is a cross section view taken along the line II-II′ depicted in FIG. 3A;

FIG. 4A is a top plan view illustrating a substrate treating apparatus in accordance with an exemplary embodiment of the present inventive concept;

FIG. 4B is a cross section view taken along the line III-III′ depicted in FIG. 4A;

FIG. 4C is a top plan view illustrating a substrate treating apparatus in accordance with an example of the substrate treating apparatus depicted in FIG. 4A;

FIG. 5A is a top plan view illustrating a substrate treating apparatus in accordance with an exemplary embodiment of the present inventive concept;

FIG. 5B is a cross section view taken along the line IV-IV′ depicted in FIG. 5A;

FIG. 6A is a top plan view illustrating a substrate treating apparatus in accordance with an exemplary embodiment of the present inventive concept; and

FIG. 6B is a cross section view taken along the line V-V′ depicted in FIG. 6A.

### DETAILED DESCRIPTION OF THE EXEMPLARY EMBODIMENTS

The foregoing and other features and aspects of the present inventive concept will be apparent from the description below, as illustrated in the accompanying drawings in which like reference numerals may refer to the same parts throughout the different views. The drawings are not necessarily drawn to scale. In the drawings, the thickness of layers and regions may be exaggerated for clarity.

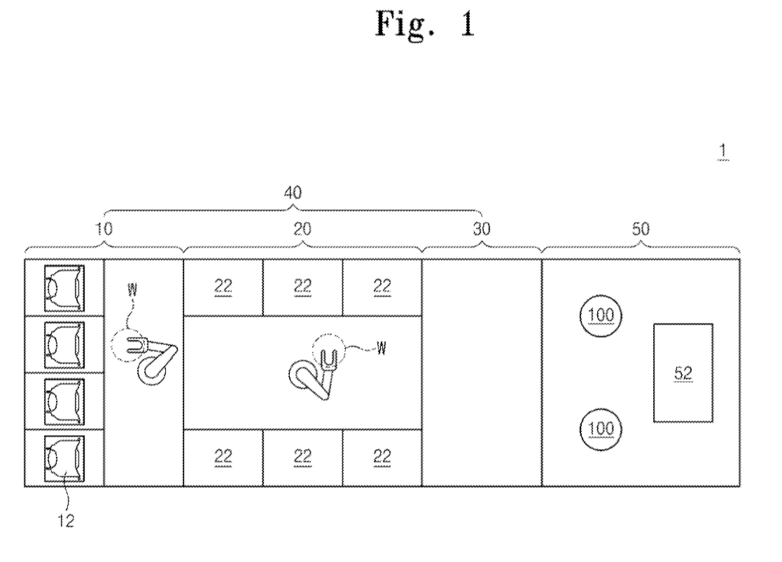

FIG. 1 is a view illustrating a photolithography process apparatus in accordance with an exemplary embodiment of the present inventive concept.

Referring to FIG. 1, a photolithography process facility 1 may include a spinner facility 40 and a photo facility 50. The spinner facility 40 may include an indexer portion 10, a process treating portion 20 and an interface portion 30. The indexer portion 10 transports a substrate (W) between a cassette 12 and the process treating portion 20. The cassette 12 may be a substrate storage vessel receiving the substrate (W). The substrate (W) may be a wafer for manufacturing a semiconductor integrated circuit chip. The process treating portion 20 may include a plurality of process modules 22. For example, the process modules 22 may include a coating module, a developing module and a bake module. The bake module may perform a bake process heating the substrate (W). The interface portion 30 can transport the substrate (W) between the processing treating portion 20 and the photo facility 50.

The photo facility 50 may perform a photolithography process. The photo facility 50 may include an exposure apparatus 52 and a substrate treating apparatus 100. The exposure apparatus 52 may form a predetermined pattern on the substrate (W). The exposure apparatus 52 may include a stepper transferring a pattern formed on a mask to the substrate (W) using a light.

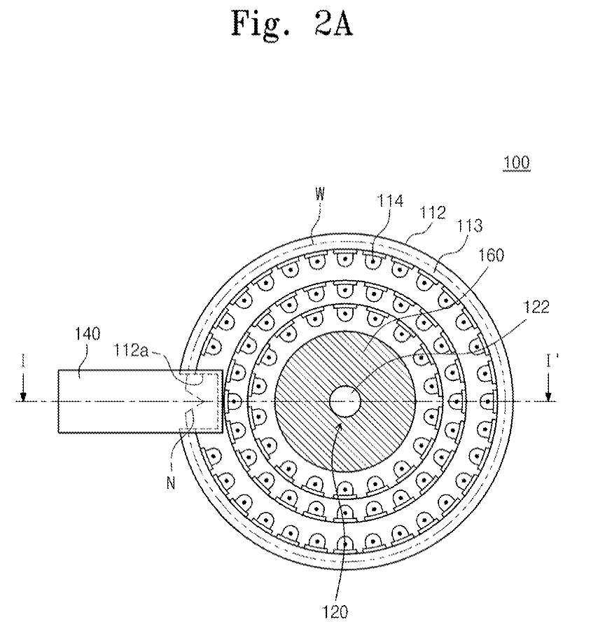

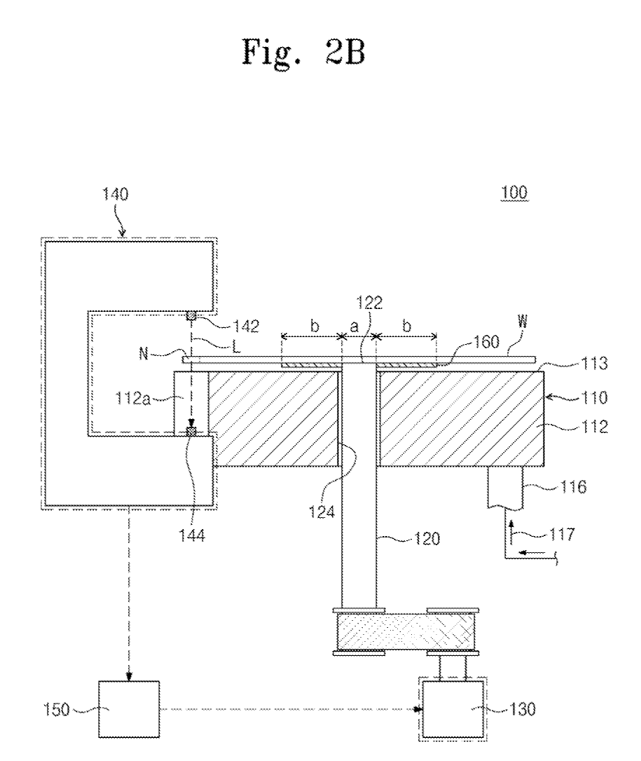

FIG. 2A is a top plan view illustrating an example of a substrate treating apparatus depicted in FIG. 1 and FIG. 2B is a cross section view taken along the line I-I′ depicted in FIG. 2A.

Referring to FIGS. 2A and 2B, the substrate treating apparatus 100 may support the substrate (W) and control a temperature of the substrate (W) at the same time. In addition, the substrate treating apparatus 100 may align the substrate (W). The substrate treating apparatus 100 may be a temperature stabilization unit (TSU).

The substrate treating apparatus 100 may include a temperature control plate 110, a central supporter 120, a driver 130, a detector 140, a controller 150 and a collision preventer 160.

The temperature control plate 110 may control a temperature of the substrate (W). For example, the temperature control plate 110 may cool or heat the substrate (W). For example, the temperature control plate 110 may include a cooling plate 112 and a cooling fluid supply line 116. The cooling plate 112 may have a disc shape. The cooling plate 112 may include a groove 112a formed on a side thereof. The groove 112a may be used as a movement path of a light (L) which is projected from the detector 140. The cooling plate 112 may have a top surface 113 facing the substrate (W). Injection nozzles 114 may be formed on the top surface 113. The cooling fluid supply line 116 may supply a cooling fluid 117 to the injection nozzles 114. The cooling fluid 117 may include a cooling gas.

The central supporter 120 may support a central region (a) of the substrate (W). For example, the central supporter 120 may have a pin shape. The central supporter 120 may be inserted into a penetration hole 124 formed on a center of the cooling plate 112. The central supporter 120 may have a support surface 122 supporting the central region (a). A vacuum hole (not shown) for pulling the substrate (W) in place using vacuum pressure may be formed on the support surface 122. The central supporter 120 may be rotated by the driver 130. Thus, the driver 130 can rotate the substrate (W) placed on the central supporter 120.

The detector 140 may align the substrate (W). For example, the detector 140 may detect a notch (N) of the substrate (W). The detector 140 may include a light emitting sensor 142 and a light receiving sensor 144. The light emitting sensor 142 and the light receiving sensor 144 may be disposed to face each other in the up and down direction (as shown). The light emitting sensor 142, the light receiving sensor 144 and the groove 112a may be foamed along a same line. At this time, when the substrate (W) is aligned at a predetermined location, the light (L) may pass through the notch (N) and the groove 112a to reach the light receiving sensor 144. Alternatively, when the substrate (W) is not aligned at a predetermined location, the light (L) is cut off by the substrate (W), so the light (L) does not reach the light receiving sensor 144.

The controller 150 may control an alignment state of the substrate (W). For example, the controller 150 may interpret data transmitted from the detector 140 and control the driver 130. The operational process of the controller 150 will be described in detail below.

The collision preventer 160 may support a peripheral region (b) surrounding the central region (a). For example, the collision preventer 160 may be a peripheral supporter supporting a peripheral region (b). The collision preventer 160 may have a plate shape disposed around an upper portion of central supporter 120. The collision preventer 160 may be mechanically combined with the central supporter 120. Alternatively, the collision preventer 160 may be provided in a single body with the central supporter 120. The collision preventer 160 may be formed from nonconductive material. For example, the collision preventer 160 may include material of a fluorine resin system. The collision preventer 160 may be in contact with the peripheral region (b) except for the central region (a). A size of collision preventer 160 may be controlled so that all the injection nozzles 114 are exposed. In addition, the size of collision preventer 160 may be controlled so that warp of the substrate (W) is prevented. As a diameter of the collision preventer 160 becomes great, the injection nozzles 114 are covered with the collision preventer 160, so a substrate cooling efficiency of the cooling plate 112 may be reduced. Alternatively, as a diameter of the collision preventer 160 becomes small, an area within which the collision preventer 160 is in contact with the substrate (W) is reduced, so a substrate support efficiency of the collision preventer 160 may be reduced. Thus, the size of collision preventer 160 may be controlled so that warp of the substrate (W) is prevented and a reduction of a substrate cooling efficiency of the cooling plate 112 is prevented at the same time.

An example of a substrate treating process of the substrate treating apparatus 100 is described in detail. Referring to FIGS. 1, 2A and 2B, the indexer portion 10 of photolithography process facility 1 may transport the substrate (W) from the cassette 12 to the process treating portion 20. The coating module among the process modules 22 may coat the substrate with a photoresist and the bake module may perform a bake process on the substrate (W). The substrate (W) may be heated to a high temperature by the bake process. The interface portion 30 may transport the substrate (W) from the process treating portion 20 to the substrate treating apparatus 100 of photo facility 50. The substrate (W) may be disposed on the central supporter 120. At this time, the central region (a) of substrate (W) may be disposed on a support surface 122 of central supporter 120 and vacuum pressure may be applied through a vacuum hole (not shown) to fix the substrate (W) to the support surface 122.

The temperature control plate 110 can control a temperature of the substrate (W). For example, since the substrate (W) is heated to a high temperature, the cooling plate 112 can cool the substrate (W) to a predetermined temperature. For example, the injection nozzles 114 may inject the cooling fluid 117 received from the cooling fluid supply line 116 into the substrate (W). The substrate (W) and the cooling plate 112 may be disposed to be closest to each other so as to improve a substrate cooling efficiency of the cooling plate 112. A distance between the substrate (W) and the cooling plate 112 can be controlled within a range of about 100 um.

The controller 150 may drive the driver 130 to rotate the central supporter 120. Thus, the substrate (W) can be rotated. When the substrate (W) rotates, the controller 150 can determine whether or not the light receiving sensor 144 receives a light (L). If the light receiving sensor 144 receives the light (L), the controller 150 may determine that the substrate (W) is aligned at a predetermined position. In this case, the controller 150 controls the driver 130 to stop a rotation of the central supporter 120, so that the substrate (W) can be aligned at the predetermined position.

When the substrate (W) is aligned, the collision preventer 160 can prevent a collision between the substrate (W) and the temperature control plate 110. For example, when the central supporter 120 rotates, a warp may occur in the peripheral region (b) of the substrate (W) not supported by the central supporter 120. Since the substrate (W) and the cooling plate 112 are very closely adjacent to each other, the substrate (W) may collide with the temperature control plate 110 when the substrate (W) rotates. In this case, the substrate (W) may be damaged or may be polluted by particles generated by the collision of the substrate (W). A distance between the substrate (W) and the cooling plate 112 may be increased so as to prevent a collision between the substrate (W) and the temperature control plate 110. However, as the distance between the substrate (W) and the cooling plate 112 is increased, a substrate cooling efficiency of the cooling plate 112 may be degraded. Thus, the collision preventer 160 supports the peripheral region (b) of substrate (W), so a collision between the substrate (W) and the cooling plate 112 may be prevented even under a state that the distance between the substrate (W) and the cooling plate 112 is maintained within 100 um.

A photolithography process may be performed on the substrate (W). For example, referring to FIG. 1, the substrate (W) may be transported from the substrate treating apparatus 100 to the exposure apparatus 52. The exposure apparatus 52 can transfer a pattern formed in a photo mask (not shown) to the substrate (W). Thus, a predetermined pattern may be formed on the substrate (W). The substrate (W) in which a photolithography process is completed may be transported from the photo facility 50 to the spinner facility 40. The substrate (W) may be transported to the process modules 22 of process treating portion 20. Among the process modules 22, the bake module may perform a bake process on the substrate (W) and the developing module may perform a developing process on the substrate (W). After the substrate (W) is received into the cassette 12 by the indexer portion 10, the substrate (W) may be taken out of the spinner facility 40.

As described above, the substrate treating apparatus 100 in accordance with exemplary embodiments of the present inventive concept may include the collision preventer 160 preventing a collision between the substrate (W) and the temperature control plate 110 when the substrate (W) rotates. At this time, when the substrate (W) rotates, a distance between the substrate (W) and the temperature control plate 110 can be maintained within a range of 100 um. Accordingly, the substrate treating apparatus 100 can prevent a collision between the substrate (W) and the temperature control plate 110 and can also effectively cool the substrate (W).

Hereinafter, examples of the substrate treating apparatus 100 are described in detail. Here, the description of common features already discussed in the substrate treating apparatus 100 described above may be omitted or simplified.

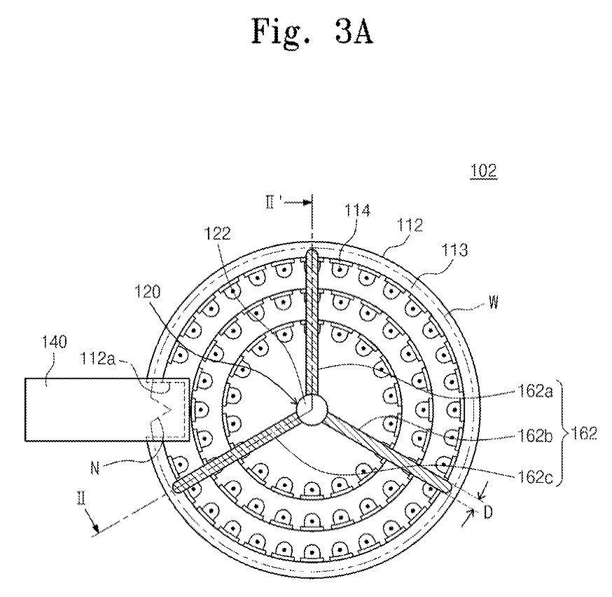

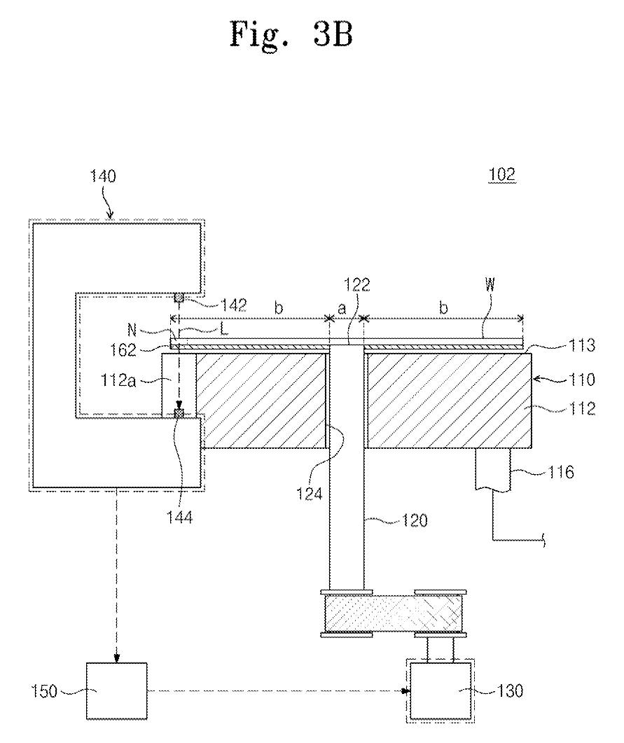

FIG. 3A is a top plan view illustrating a substrate treating apparatus in accordance with an exemplary embodiment of the present inventive concept. FIG. 3B is a cross section view taken along the line II-II′ depicted in FIG. 3A.

Referring to FIGS. 3A and 3B, a substrate treating apparatus 102 in accordance with an exemplary embodiment of the present inventive concept may include a temperature control plate 110, a central supporter 120, a driver 130, a detector 140, a controller 150 and a collision preventer 162.

The temperature control plate 110 may include a cooling plate 112 and a cooling fluid supply line 116. The cooling plate 112 may include a groove 112a used as a moving path of a light (L). Injection nozzles 114 connected to the cooling fluid supply line 116 may be formed on a top surface 113 of the cooling plate 112.

The central supporter 120 may have a pin shape. The central supporter 120 may be inserted into a penetration hole 124 formed in a center of the cooling plate 112. The central supporter 120 may have a support surface 122 supporting a central region (a) of the substrate (W). The central supporter 120 may be rotated by the driver 130.

The detector 140 may include a light emitting sensor 142 and a light receiving sensor 144. The light emitting sensor 142 may project a light (L) to the light receiving sensor 144. When the substrate (W) is disposed on a predetermined position, the light (L) may reach the light receiving sensor 144 after sequentially passing through a notch (N) and the groove 112a. Accordingly, the detector 140 can detect the notch (N) of the substrate (W).

The detector 150 may interpret data transmitted from the detector 140 to control the driver 130. An operation process of the controller 150 is similar to that described above with reference to FIGS. 2A and 2B.

The collision preventer 162 supports a peripheral region (b) of the substrate (W) to prevent a collision between the substrate (W) and the temperature control plate 110. Thus, the collision preventer 162 may be a peripheral region supporter supporting the peripheral region (b). For example, the collision preventer 162 may be a peripheral supporter including a plurality of bars 162a, 162b and 162c. Each of the plurality of bars 162a, 162b and 162c may have a shape extending in a direction (hereinafter referred to as horizontal direction) perpendicular to a lengthwise direction of the central supporter 120 from an upper portion of the central supporter 120. At this time, the plurality of bars 162a, 162b and 162c may extend to an edge of substrate (W). The plurality of bars 162a, 162b and 162c may be disposed to have an equal angle using the central supporter 120 as a central axis. Also, the plurality of bars 162a, 162b and 162c may be controlled to have widths (D) of 1 mm to 10 mm.

The collision preventer 162 supports the peripheral region (b) of the substrate (W) to prevent a warp of the substrate (W). Also, the plurality of bars 162a, 162b and 162c may expose injection nozzles 114 of the cooling plate 112 through a space between the plurality of bars 162a, 162b and 162c. Thus, the substrate treating apparatus 102 may reduce instances of a flow of a cooling gas injected by the injection nozzles 114 being interrupted by the collision preventer 162. Since the collision preventer 162 having the structure described above supports even an edge of the substrate (W), the substrate (W) may be stably supported.

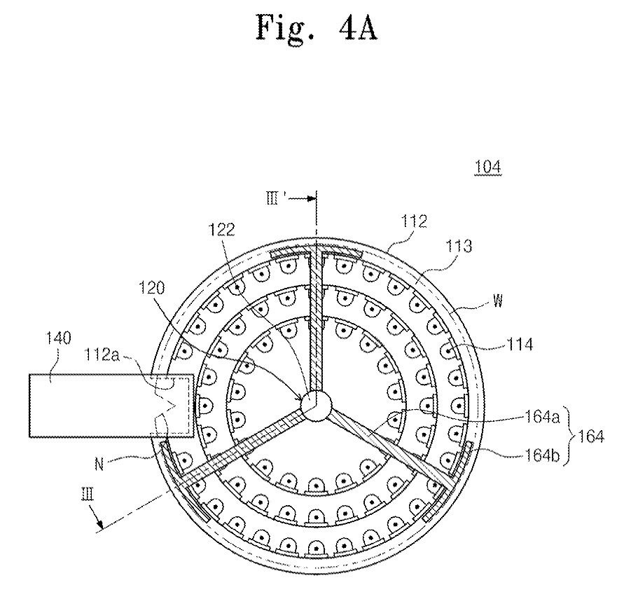

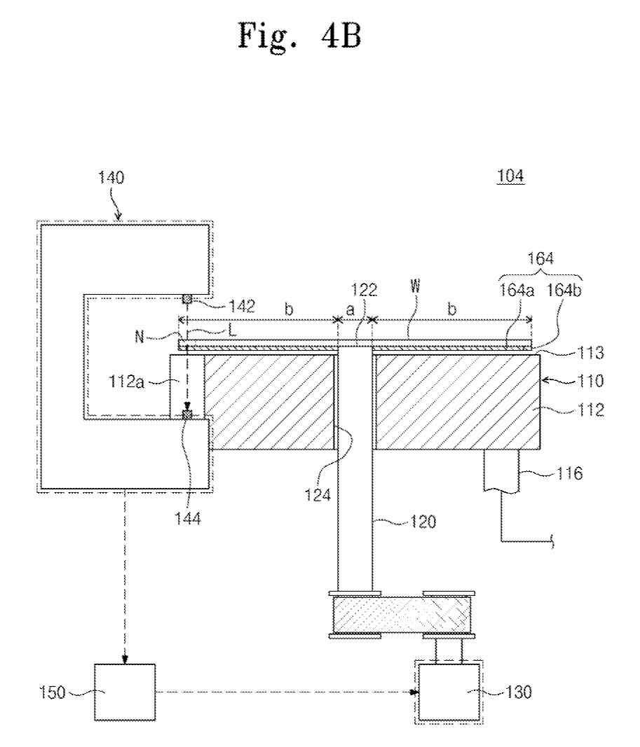

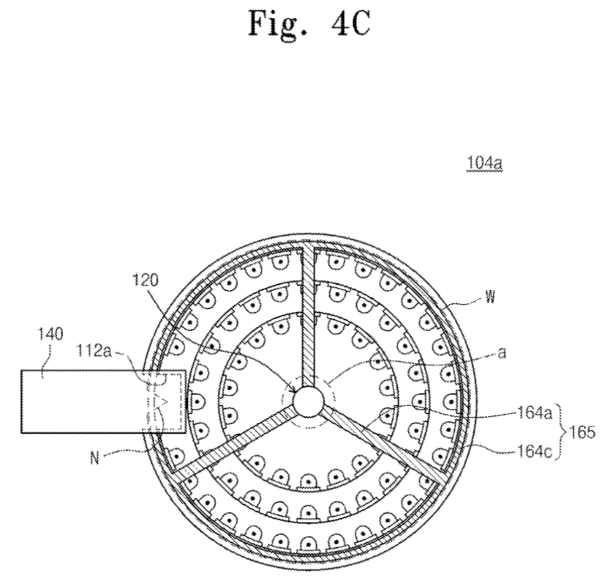

FIG. 4A is a top plan view illustrating a substrate treating apparatus in accordance with an exemplary embodiment of the present inventive concept. FIG. 4B is a cross section view taken along the line III-III′ depicted in FIG. 4A. FIG. 4C is a top plan view illustrating a substrate treating apparatus in accordance with an example of the substrate treating apparatus depicted in FIG. 4A.

Referring to FIGS. 4A and 4B, a substrate treating apparatus 104 in accordance with an exemplary embodiment of the present invention may include a temperature control plate 110, a central supporter 120, a driver 130, a detector 140, a controller 150 and a collision preventer 164.

The temperature control plate 110 may include a cooling plate 112 and a cooling fluid supply line 116. The cooling plate 112 may include a groove 112a used as a moving path of a light (L). Injection nozzles 114 connected to the cooling fluid supply line 116 may be formed on a top surface 113 of cooling plate 112.

The central supporter 120 may have a pin shape. The central supporter 120 may be inserted into a penetration hole 124 formed in a center of the cooling plate 112. The central supporter 120 may have a support surface 122 supporting a central region (a) of the substrate (W). The central supporter 120 may be rotated by the driver 130.

The detector 140 may include a light emitting sensor 142 and a light receiving sensor 144. The light emitting sensor 142 may project a light (L) to the light receiving sensor 144. When the substrate (W) is disposed on a predetermined position, the light (L) may reach the light receiving sensor 144 after sequentially passing through a notch (N) and the groove 112a. Accordingly, the detector 140 can detect the notch (N) of the substrate (W).

The controller 150 may interpret data transmitted from the detector 140 to control the driver 130. An operation process of the controller 150 may be similar to that described above with reference to FIGS. 2A and 2B.

The collision preventer 164 supports a peripheral region (b) of the substrate (W) to prevent a collision between the substrate (W) and the temperature control plate 110. Thus, the collision preventer 164 may be a peripheral region supporter supporting the peripheral region (b). For example, the collision preventer 164 may be a peripheral supporter including a first bar 164a and a second bar 164b. The first bar 164a may have a shape similar to the bar 162 described above with reference to FIGS. 3A and 3B. The first bar 164a may have a shape extending along a horizontal direction from an upper portion of the central supporter 120. The second bar 164b is connected to an edge of the first bar 164a and may disposed in a direction perpendicular to a lengthwise direction of the first bar 164a. At this time, the second bar 164b may have a shape concavely rounded toward the central supporter 120. The collision preventer 164 may be disposed to have an equal angle using the central supporter 120 as a central axis.

The shape of the collision preventer 164 may be different than as described above. Referring to FIG. 4C, a substrate treating apparatus 104a may include a central supporter 120, a detector 140 and a collision preventer 165 (e.g., a peripheral supporter) including a first bar 164a and a second bar 164c. The first bar 164a may have the same structure as the first bar 164a described above with reference to FIG. 4B. The second bar 164c may be connected to an edge of the first bar 164a. Thus, the second bar 164c may have a ring shape extending along an edge of the substrate (W). The second bar 164c can support the edge of substrate (W). The substrate treating apparatus 104a described above can stably support the substrate (W) because the second bar 164c supports the edge of substrate (W).

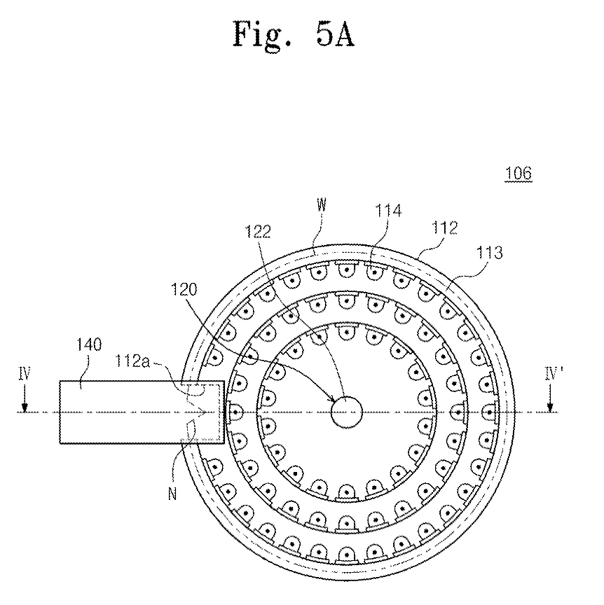

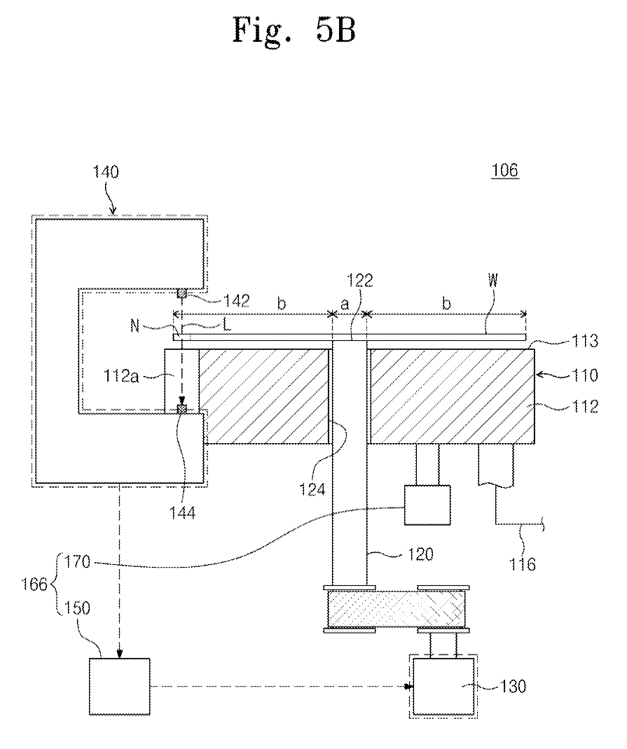

FIG. 5A is a top plan view illustrating a substrate treating apparatus in accordance with an exemplary embodiment of the present inventive concept. FIG. 5B is a cross section view taken along the line IV-IV′ depicted in FIG. 5A.

Referring to FIGS. 5A and 5B, a substrate treating apparatus 106 in accordance with an exemplary embodiment of the present invention may include a temperature control plate 110, a central supporter 120, a driver 130, a detector 140 and a collision preventer 166.

The temperature control plate 110 may include a cooling plate 112 and a cooling fluid supply line 116. The cooling plate 112 may include a groove 112a used as a moving path of a light (L). Injection nozzles 114 connected to the cooling fluid supply line 116 may be formed on a top surface 113 of the cooling plate 112.

The central supporter 120 may have a pin shape. The central supporter 120 may be inserted into a penetration hole 124 formed in a center of the cooling plate 112. The central supporter 120 may have a support surface 122 supporting a central region (a) of the substrate (W). The central supporter 120 may be rotated by the driver 130.

The detector 140 may include a light emitting sensor 142 and a light receiving sensor 144. The light emitting sensor 142 may project a light (L) to the light receiving sensor 144. When the substrate (W) is disposed on a predetermined position, the light (L) may reach the light receiving sensor 144 after sequentially passing through a notch (N) and the groove 112a. Accordingly, the detector 140 can detect the notch (N) of the substrate (W).

The collision preventer 166 can prevent a collision between the substrate (W) and the temperature control plate 110. For example, the collision preventer 166 may include a controller 150 and an elevator 170. The controller 150 may interpret data transmitted from the detector 140 to control the driver 130. An operation process of the controller 150 may be similar to that described above with reference to FIGS. 2A and 2B.

The elevator 170 can control a distance between the substrate (W) and the temperature control plate 110. For example, the elevator 170 can move the temperature control plate 110 up and down. The elevator 170 may prevent a collision between the substrate (W) and the cooling plate 112. When the substrate (W) is aligned, the controller 150 can rotate the substrate (W) by rotating the central supporter 120. The controller 150 can move the cooling plate 112 down before rotating the central supporter 120. Thus, a distance between the substrate (W) and the cooling plate 112 increases, so a collision between the substrate (W) and the cooling plate 112 can be prevented when the substrate (W) rotates. After that, when the light receiving sensor 144 receives a light (L) through the notch (N), the controller 150 stops the driver 130 to stop a rotation of the central supporter 120. The controller 150 can control the elevator 170 so that the cooling plate 112 moves up. Accordingly, when the substrate (W) rotates, the controller 150 increases a distance between the substrate (W) and the cooling plate 112 to prevent a collision between the substrate (W) and the cooling plate 112.

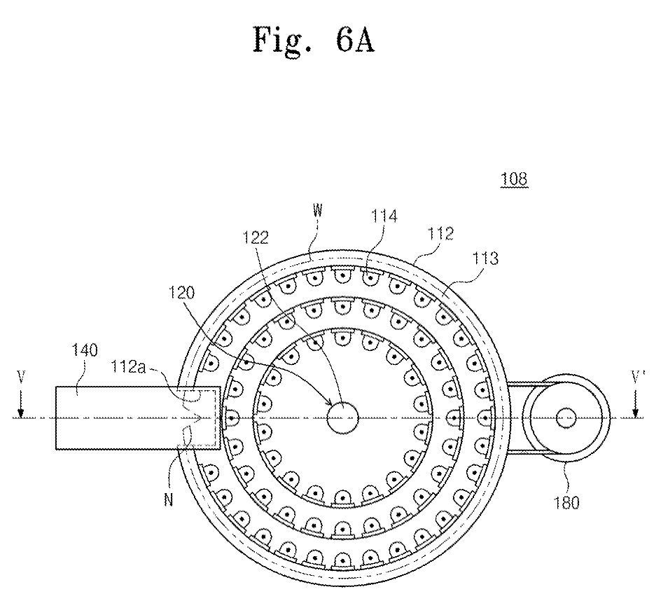

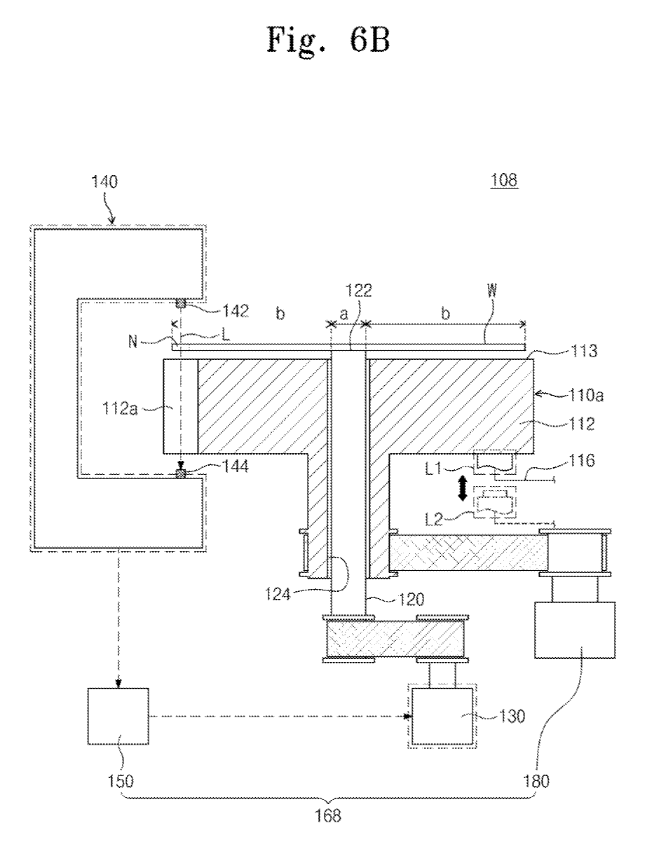

FIG. 6A is a top plan view illustrating a substrate treating apparatus in accordance with an exemplary embodiment of the present inventive concept. FIG. 6B is a cross section view taken along the line V-V′ depicted in FIG. 6A.

Referring to FIGS. 6A and 6B, a substrate treating apparatus 108 in accordance with an exemplary embodiment of the present invention may include a temperature control plate 110, a central supporter 120, a detector 140 and a collision preventer 168. The collision preventer 168 may include a first driver 130, a second driver 180 and a controller 150 controlling the first and second drivers 130 and 180.

The temperature control plate 110 may include a cooling plate 112 and a cooling fluid supply line 116. The cooling plate 112 may have a disc shape. The cooling plate 112 may include a groove 112a used as a moving path of a light (L). Injection nozzles 114 connected to the cooling fluid supply line 116 may be formed on a top surface 113 of the cooling plate 112. The cooling plate 112 may be rotated by the second driver 180. The second driver 180 may include a rotating motor rotating the cooling plate 112. The cooling fluid supply line 116 may be combined with the cooling plate 112. The cooling fluid supply line 116 may also be removed from the cooling plate 112. The cooling fluid supply line 116 may move between a supply location (L1) and a standby location (L2). The supply location (L1) may be a location of the cooling fluid supply line 116 for supplying the cooling fluid to the cooling plate 112. The cooling fluid supply line 116 located at the supply location (L1) may be combined with the cooling plate 112. The standby location (L2) may be a location at which the cooling fluid supply line 116 is located before being located at the supply location (L1). The cooling fluid supply line 116 located at the standby location (L2) may be separated from the cooling plate 112. Thus, when the cooling fluid supply line 116 is located at the standby location (L2), the rotation of the cooling plate 112 is not interrupted. The collision preventer 168 may further include a third driver (not shown) moving the cooling fluid supply line 116 between the supply location (L1) and the standby location (L2).

The central supporter 120 may have a pin shape. The central supporter 120 may be inserted into a penetration hole 124 formed in a center of the cooling plate 112. The central supporter 120 may have a support surface 122 supporting a central region (a) of the substrate (W). The central supporter 120 may be rotated by the first driver 130.

The detector 140 may include a light emitting sensor 142 and a light receiving sensor 144. The light emitting sensor 142 may project a light (L) to the light receiving sensor 144. When the substrate (W) is disposed on a predetermined position, the light (L) may reach the light receiving sensor 144 after sequentially passing through a notch (N) and the groove 112a. Accordingly, the detector 140 can detect the notch (N) of the substrate (W). The detector 140 may be set up so as not to interrupt a rotation of the cooling plate 112. For example, the emitting sensor 142, the light receiving sensor 144 and a sensor supporter supporting the emitting sensor 142 and the light receiving sensor 144 may be disposed spaced apart from the cooling plate 112.

The collision preventer 168 may reduce instances of damage of the substrate (W) caused by a collision between the substrate (W) and the temperature control plate 110. For example, the controller 150 may interpret data transmitted from the detector 140 to control the first and second drivers 130 and 180. The controller 150 may control the third driver to locate the cooling fluid supply line 116 at the standby location (L2). For an alignment of the substrate (W), the controller 150 may drive the first driver 130 to rotate the substrate (W). Concurrently, the controller 150 may drive the second driver 180 to rotate the cooling plate 112. At this time, the controller 150 may control the first and second drivers 130 and 180 so that a rotation speed of the substrate (W) becomes equal to that of the cooling plate 112. Thus, when the substrate (W) rotates, even though the substrate (W) collides with the cooling plate 112, a shock given to the substrate (W) may be minimized because the substrate (W) and the cooling plate 112 rotate at the same speed. When an alignment of the substrate (W) is completed, the controller 150 may control the third driver so that the cooling fluid supply line 116 is located at the supply location (L1).

The substrate treating apparatus in accordance with the present invention may prevent a warp of a substrate to prevent a damage of the substrate caused by a collision between the substrate and a temperature control plate. Thus, exemplary embodiments of the present inventive concept may effectively treat cooling and an alignment of the substrate.

The above-disclosed subject matter is to be considered illustrative, and not restrictive of the present inventive concept.

What is claimed is:

1. A photolithography process facility comprising a substrate treating apparatus, the substrate treating apparatus comprising:
a temperature control plate controlling a temperature of a substrate;
a central supporter having a pin shape and vertically penetrating the temperature control plate and supporting a central region of the substrate; and
a collision preventer preventing a collision between the substrate and the temperature control plate.

2. The photolithography process facility of claim 1, wherein the temperature control plate comprises injection nozzles injecting a cooling fluid to the substrate.

3. The photolithography process facility of claim 1, wherein the collision preventer comprises a peripheral region supporter of a plate shape surrounding an upper circumference of the central supporter to support a peripheral region of the substrate.

4. The photolithography process facility of claim 1, wherein the collision preventer comprises a bar horizontally extending from the central supporter.

5. The photolithography process facility of claim 1, wherein the collision preventer comprises:
a first bar having a bar shape horizontally extending from the central supporter; and
a second bar connected to an edge of the first bar to support an edge of the substrate.

6. The photolithography process facility of claim 1, wherein the collision preventer comprises:
a plurality of first bars having a bar shape horizontally extending from the central supporter; and
a second bar having a ring shape connecting edges of plurality of first bars to each other.

7. The photolithography process facility of claim 1, wherein the collision preventer comprises:
an elevator moving the temperature control plate up and down; and
a controller controlling the elevator.

8. The photolithography process facility of claim 1, wherein the collision preventer comprises:
a first driver rotating the central supporter;
a second driver rotating the temperature control plate; and
a controller controlling the first and second drivers, wherein the controller controls the first and second drivers so that a rotation speed of the central supporter becomes equal to a rotation speed of the temperature control plate.

9. The photolithography process facility of claim 1, wherein the temperature control plate comprises a cooling fluid supply line supplying a cooling fluid and wherein the cooling fluid supply line can move between a supply location at which the cooling fluid supply line is combined with the temperature control plate and a standby location at which the cooling fluid supply line is separated from the temperature control plate.

10. The photolithography process facility of claim 1, wherein the central supporter has a support surface with a vacuum hole for pulling the substrate in place using vacuum pressure.

11. The photolithography process facility of claim 1, further comprising:
a spinner facility with a process treatment portion for processing a substrate, an indexer portion for transporting the substrate from a cassette to the process treatment portion, and an interface portion for transporting the substrate out of the spinner facility; and
a photo facility for receiving the substrate from the interface portion, treating the substrate using the substrate treating apparatus, and exposing the substrate using an exposure apparatus to transfer a pattern on a photomask to the substrate.

12. The photolithography process facility of claim 1, further comprising:
a detector detecting alignment of the substrate; and
a controller for rotating the substrate until the detector detects proper alignment thereof.

13. A photolithography process facility, comprising:
a spinner facility with a process treatment portion for processing a substrate, an indexer portion for transporting the substrate from a cassette to the process treatment portion, and an interface portion for transporting the substrate out of the spinner facility; and
a photo facility for receiving the substrate from the interface portion, treating the substrate using a substrate treating apparatus, and exposing the substrate using an exposure apparatus to transfer a pattern on a photomask to the substrate, the substrate treating apparatus comprising:
a temperature control plate controlling a temperature of a substrate, the temperature control plate including a plurality of injection nozzles for cooling the substrate by injection of a cooling gas;
a central supporter having a pin shape and vertically penetrating the temperature control plate and supporting a central region of the substrate;
a collision preventer, on a peripheral region of the central supporter, preventing a collision between the substrate and the temperature control plate, wherein the collision preventer comprises one or more support bars that are perpendicular to the central axis of the central supporter, and provide support to an edge of the substrate;
a detector detecting alignment of the substrate; and
a controller for rotating the substrate until the detector detects proper alignment thereof.

14. The photolithography process facility of claim 13, wherein the collision preventer comprises:
a first bar having a bar shape horizontally extending from the central supporter; and
a second bar connected to an edge of the first bar to support an edge of the substrate.

15. The photolithography process facility of claim 13, wherein the collision preventer comprises:
a plurality of first bars having a bar shape horizontally extending from the central supporter; and
a second bar having a ring shape connecting edges of plurality of first bars to each other.

16. The photolithography process facility of claim 13, wherein the collision preventer comprises:
an elevator moving the temperature control plate up and down; and
a controller controlling the elevator.
